(19) United States
(12) Patent Application Publication
(10) Pub. No.: US 2006/0031367 A1
(43) Pub. Date: Feb. 9, 2006

(54) Instant messaging and presence using virtual devices

(76) Inventors: John Buford, Lawrenceville, NJ (US); Mahfuzur Rahman, South Brunswick, NJ (US); Wanrong Lin, Princeton, NJ (US)

Correspondence Address: HARNESS, DICKEY & PIERCE, P.L.C., P.O. BOX 828, BLOOMFIELD HILLS, MI, 48303, US

(21) Appl. No.: 10/862,164

(22) Filed: Jun. 4, 2004

(51) Int. Cl. G06F 15/16

(52) U.S. Cl. 709/207

(57) ABSTRACT

The virtual instant messaging system adds instant messaging and presence capability to devices and appliances which are not natively designed for instant messaging. The virtual instant messaging system performs the physical communication handling and semantic translation issues to allow legacy devices to operate within the instant messaging paradigm. Virtual devices, representing real devices or information sources, may be constructed, on the fly as needed, or on a more permanent or persistent basis. Multiple virtual devices may be combined to compose or synthesize a new virtual device, affording capabilities not found in the real world devices or information sources themselves.

### BACKGROUND OF THE INVENTION

The present invention relates generally to instant messaging systems. More particularly, the invention relates to a virtual instant messaging system that extends the virtual messaging paradigm to devices and information sources that do not inherently support instant messaging. Further, the invention relates to an instant messaging system with which new virtual instant message devices can be synthesized or composed of other disparate devices and information sources.

The instant messaging paradigm has become quite popular today, particularly among users of networked computers, cellular telephones and other information appliances. The basic instant messaging paradigm supports real time text messages (text chat sessions) among users. Associated with instant messaging is the concept of “presence”. Presence is, in effect, a state variable signifying whether a particular user is currently available to participate in an instant messaging session. In some forms, the presence information may also include additional data to reflect what the user's anticipated future availability may be. The instant messaging paradigm has recently been extended to support audio and video chat sessions, allowing users to communicate by voice and picture. In addition to real time text messages (and audio/video messages) the instant messaging paradigm can also be extended to permit additional data to be embedded in or associated with the instant message. This additional data can include references to other information sources (URL information) and attached files containing additional information. The instant messaging paradigm is somewhat of a unique cross between a telephone conversation and an e-mail message.

### SUMMARY OF THE INVENTION

The present invention seeks to extend the instant messaging paradigm in several useful respects. Currently, instant messages may be utilized only with devices that are specifically configured for that purpose. These devices include personal computers and cellular telephones. However, there are numerous other consumer devices and appliances that are not inherently capable of supporting instant messaging. To give several examples, VCRs, television sets and other home entertainment devices do not currently support instant messaging. Likewise, home air conditioning systems, laundry and kitchen appliances, and the like, also do not support instant messaging. If these devices could support instant messaging, then users would gain the ability to control and monitor these devices in an entirely new and convenient way.

The present invention provides a virtual instant messaging system that can add instant messaging capability to these legacy devices. Thus, the invention will allow a user to send an instant message to his or her VCR, commanding it to record a program and then forward that recorded program to another instant messaging user. By integrating with the instant messaging presence data, important state information about a controlled device can be communicated through the instant messaging infrastructure. Thus, a user could access a controlled device through instant messaging and determine the state of the device's battery charge, it's current mode of operation, and the like.

In the foregoing examples, the virtual instant messaging system makes it possible to interact with a single legacy device. However, the virtual instant messaging system of the invention is not limited to use with a single device. Rather, the virtual instant messaging system may interact with multiple devices, thereby synthesizing a new virtual device having features and functionality not heretofore available.

For example, the system can be used to create a virtual device that interacts with and draws information from one or more information sources, while simultaneously interacting with one or more physical devices. Thus, for example, a new virtual information appliance may be configured by the user to (a) monitor selected information sources such as web sites for the occurrence of pre-specified events and then, for example, causing the VCR to record a program selected in accordance with the information extracted from the information source web sites.

While this one example illustrates the concept of the virtual device, the possible permutations for creating new virtual devices is endless. In this regard, it is anticipated that the future will bring numerous low cost sensors and information sources that the creative user will be able to connect up to form new virtual devices through the instant messaging paradigm. The present invention makes this possible.

According to one aspect of the invention, the virtual instant messaging system acts as an interface between devices that are configured for instant messaging and devices (and other information sources) that are not. The virtual instant messaging system is configured to perform the necessary semantic translation between the instant messaging paradigm of the instant messaging-ready device and the legacy device. The virtual instant messaging system also handles the necessary aspects of physical communication with the legacy device. In one presently preferred form, the virtual instant messaging system also includes capabilities for virtual device synthesis or composition, whereby new virtual devices can be “created” by the user from other existing devices and information sources.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention. Accordingly, for a more complete understanding of the invention, its objects and advantages, refer to the remaining specification and to the accompanying drawings.

### BRIEF DESCRIPTION OF THE DRAWINGS

The present invention will become more fully understood from the detailed description and the accompanying drawings, wherein:

FIG. 1 is an entity diagram illustrating the virtual instant messaging system and its component parts in communication with an exemplary instant message device together with an exemplary legacy device and information source;

FIG. 2 is a component block diagram illustrating deployment of the virtual device representing a real device and representing an information source;

FIG. 3 is an exemplary use case diagram showing some of the capabilities of the inventive technology;

FIG. 4 is a second use case diagram also useful in understanding the invention;

FIG. 5 is yet another use case diagram illustrating how information sources may be combined into a virtual instant message device.

### DETAILED DESCRIPTION OF THE PREFERRED EMBODIMENTS

The following description of the preferred embodiment(s) is merely exemplary in nature and is in no way intended to limit the invention, its application, or uses.

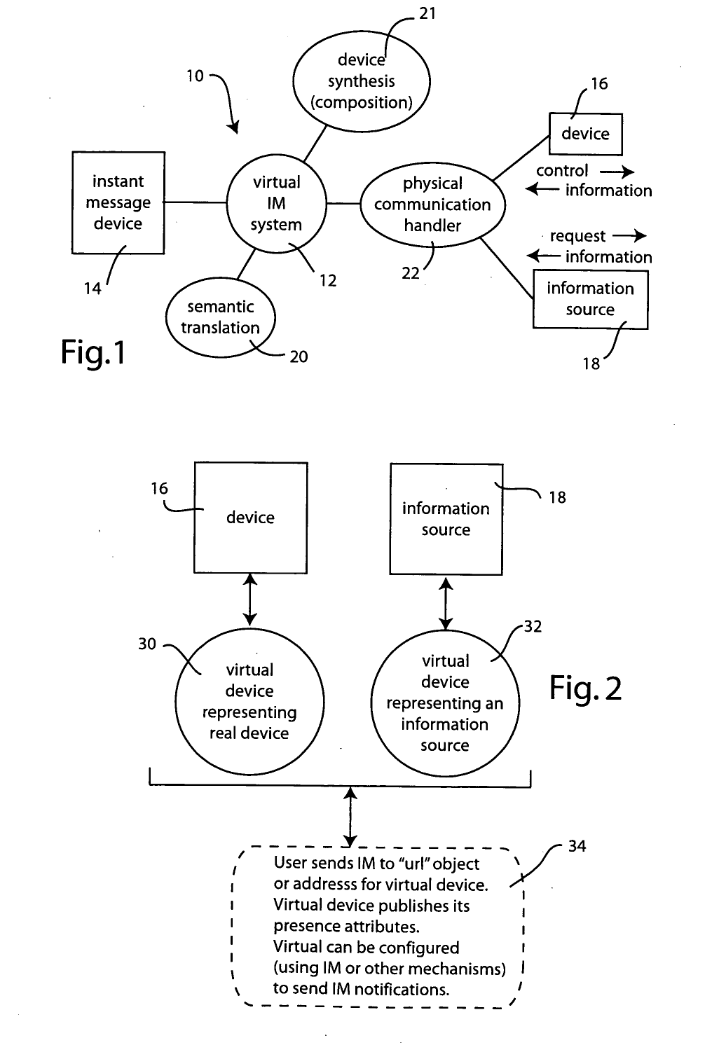

Referring first to FIG. 1, the instant messaging system for implementing virtual devices is illustrated generally at 10. The system includes a virtual instant messaging system component 12 that acts as the interface between an instant messaging device 14 and the legacy device 16, or other information source 18. The virtual instant messaging system 12 is configured to comply with instant messaging protocols and is thereby capable of exchanging messages with other users as well as learning the availability of other users by accessing the presence and availability data associated with the instant messaging protocol. Currently, some of the key instant messaging protocols include SIP/SIMPLE; Wireless Village, and IETF XMPP. There are also other proprietary instant messaging protocols. The virtual instant messaging system 12 is preferably configured to operate with one or more of these instant messaging protocols.

By virtue of conforming to the instant messaging protocols, the system 12 can communicate with a growing number and variety of instant message devices 14. Such devices include cell phones, personal digital assistants (PDA), personal computers, and other instant messaging-enabled devices. However, there remain numerous devices which are not currently equipped with instant messaging and presence capabilities. These include some brands of cell phones and PDAs, telematics equipment in vehicles, television sets, set top boxes, digital cameras and digital video cameras, home appliances, home security systems, residential gateways, GPS receivers, home entertainment systems, audio/video systems, home appliances, digital cameras, video camcorders, surveillance cameras, door locks and perimeter control systems, and security systems and the like, including combinations of one or more of the foregoing.

In order to communicate with such legacy devices 16, the virtual instant messaging system 12, includes a semantic translation component 20. This component performs the necessary translation between the instant messaging paradigm and the paradigm of the legacy device. In addition, because the virtual instant message system 12 must communicate with legacy devices at a physical level, a physical communication handler 22 is preferably included. The communication handler allows the virtual IM system 12 to physically communicate with legacy devices 16, and also with other information sources 18.

By way of example, a legacy VCR device may be configured for communication using infrared (IR) remote control signals. The physical communication handler 22 would therefore include the necessary physical hardware (infrared transmitter/transceiver) and the associated command and control data needed to communicate with device 16 through its remote control port. In another example, device 16 may be a home automation device, operated using X-10 control signals sent over the house wiring. In this case, the physical communication handler 22 would include a suitable X-10 interface for coupling to the house wiring and would again include the necessary command and control data to allow messages to be sent to (and optionally received from) the legacy device 16. Of course, there are numerous communication links in use today, including hard wired links, wireless radio frequency links and optical links, to name a few. In general, the physical communication handler 22 is configured to accommodate one or more of these physical links, as required.

In addition to establishing the physical connection to the legacy device, the communication handler 22 may also be configured to handle higher level communication layers. Thus the communication handler 22 may be capable of implementing the TCP/IP protocol used for networked communication in many systems that are popular today. Thus the communication handler 22 would be capable of communicating with an information source 18, such as an information source located on the internet. Examples of such sources thus include, internet web sites, internet ftp (file transfer protocol) sites and email systems.

While the physical communication handler 22 addresses the basic problem of how to connect a legacy device or information source with the virtual IM system, the semantic translation component 20 addresses a different aspect. The semantic translation component 20 performs the conversion between the control and use semantics of the legacy device and the semantics that a user would expect in an instant message device.

By way of example, a legacy VCR device is operated using buttons to cause various operations to be performed, such as record, fast forward, playback, etc. The semantic translation component 20 converts these legacy-device semantics into instant messaging commands that a user can type as text, or speak as a chat message that is intended to control the legacy device. Thus, the user could enter the text “turn on VCR; record channel 26.” The semantic translation component 20 would convert this text message into the required semantics that are understood by the VCR device.

In addition to semantic translation for control of legacy devices, the virtual IM system can include a device synthesis or device composition component 21 with which the user can “create” or define new virtual devices by combining several existing devices and/or information sources.

The virtual IM system can be deployed on any convenient hardware platform. For example, within the home, the virtual IM system might be implemented on the home computer or home gateway. Essentially, any system having suitable processor and memory capabilities can be used to host the virtual IM system. Thus, the virtual IM system could be run on either a general purpose computer or on a special purpose computer, such as a set top box, for example. In addition, the virtual IM system can be deployed in a distributed fashion, where different components of the IM system are hosted by different computers or computer systems that are networked together.

The virtual IM system, in effect, creates a virtual device that represents a real device or an information source. This is illustrated in FIG. 2. In FIG. 2, the virtual device 30 represents real device 16 while virtual device 32 represents information source 18. It will be understood that these two virtual devices 30 and 32 may be implemented separately or in various combinations to synthesize or compose a more complex virtual device, possibly one which has no one-to-one correspondence to any single device or single information source in the real world.

As seen from the instant message vantage point, shown diagrammatically at 34, the virtual devices 30 and 32 appear as any other instant message-producing/consuming entity. Thus, a user can send an instant message to the virtual device, by specifying its URL or address. The virtual device publishes its presence attributes, which can be perceived by other instant message-capable systems within the instant messaging infrastructure. Virtual devices can be configured, using instant messaging or other mechanisms, to send instant message notifications. Thus if a legacy device, such as device 16 emits a “low battery” warning, that message can be translated by the virtual device 30 and sent as an instant message notification over the instant messaging infrastructure.

The virtual device is logically an intermediary between some instant messaging and presence (IMP) software and devices or other information systems, web servers, and the like. The virtual device can reside on a server on the internet, on a home computer, on a service provider's system, or elsewhere. In general, the virtual device utilizes network connectivity to the actual devices or information objects that it represents. However, this connectivity only requires that the device content and status be made accessible, so that it can be translated as needed into instant messages. Similarly, the virtual device implementation should have network connectivity to information objects for which it is the mediator.

A set of virtual devices may be provided by a single system, or there can be multiple instantiations of the implementation system, one per virtual device instance. A virtual device could be implemented as a server, web server, proxy, gateway, or other intermediary architectures.

The virtual device may be implemented to support object-oriented properties, including persistence, reusability, inheritance, and the like. For example, a virtual device can be created dynamically as needed by the user, and then decommissioned or deleted; or it can be long-lived. There can be multiple instantiations of a virtual device for the same physical device, in case the physical device is moved, say from home to office. An arbitrary information object could be usefully participating in instant messaging sessions. Such an object may be long-lived (persistent) or temporary. It can be shared by several users. One mechanism for device sharing can be definition of a group which the device subscribes to.

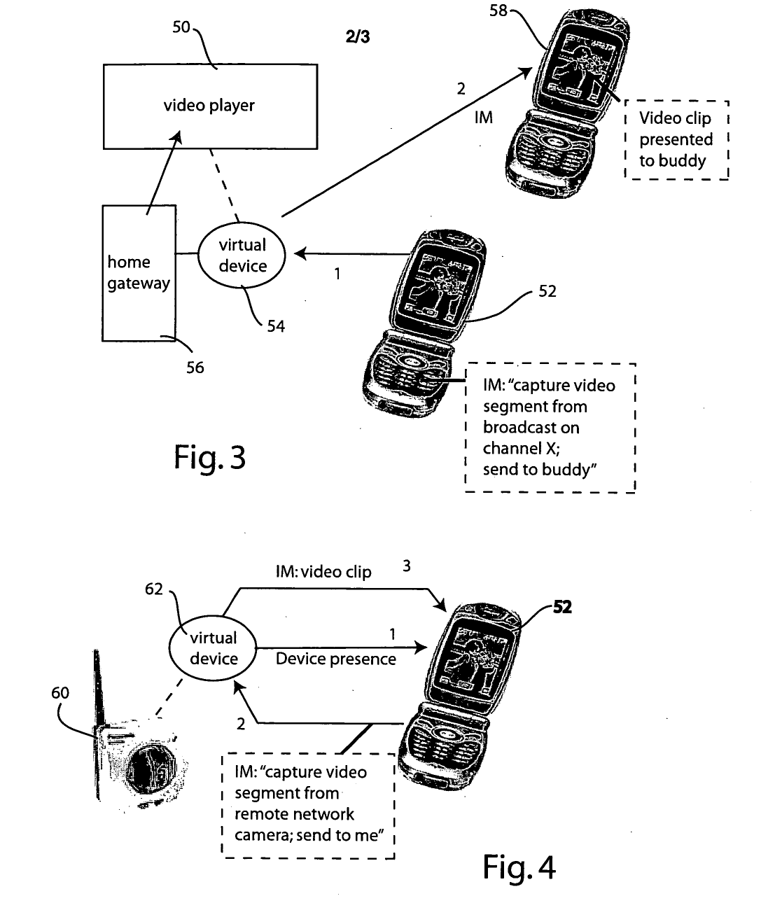

As a further illustration of the invention, refer now to FIGS. 3-5, which illustrate several use case scenarios. In FIG. 3, video player 50 is operated as a virtual IMP device. An IMP enabled cell phone 52 sends an instant message to the video player using its virtual device address. The virtual device is shown diagrammatically in FIG. 2 at 54. In this case, the virtual device may be implemented on the home network or home gateway computer system 56. Computer system 56 should include a suitable physical communication link with the video player. An RF wireless link or infrared link represent two possibilities.

The message sent from cell phone 52 may contain any device-specific control commands, such as play, record, etc. In FIG. 3, the instant message requests the video player 50 to capture a live video segment at a certain time and then send it as an instant message to another IMP entity, such as another cell phone 58.

FIG. 4 shows a video camera 60 operating as a virtual IMP device. In FIG. 4 the virtual device is shown diagrammatically at 62. In general, the digital video camera may have a stored photo or video clip, a battery level indicator, a record of its location (within the home) all as stored state information. The virtual IMP device 62 can receive messages from a user, such as a user operating cell phone 52. The message might request state information, such as “send me images 1 and 2;” “send me a list of images;” “send me your location in the house.” The messages are parsed and processed by the virtual device. The virtual device then communicates with the camera 60 to perform the requests. Similarly, the virtual device can be enabled to automatically send messages for certain events, such as low battery indication or image storage full indication. Operating status of the device will be represented as device presence status information in the instant messaging paradigm.

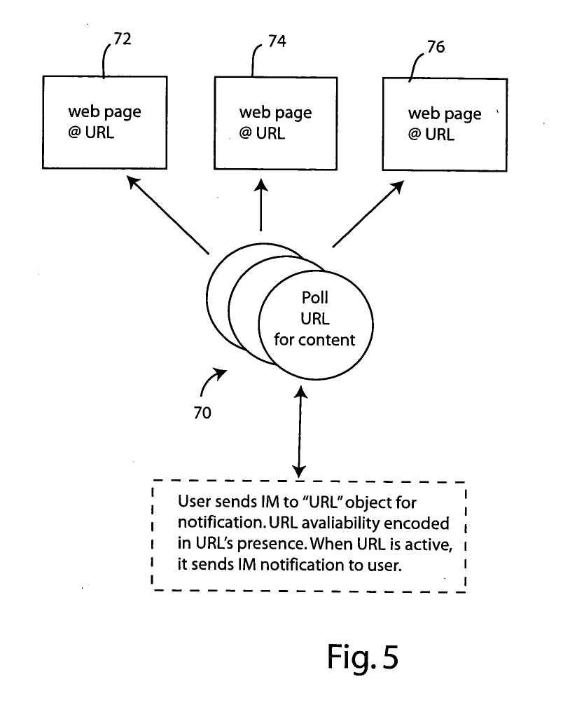

FIG. 5 illustrates another use case example, where the virtual devices, shown at 70, are each configured to poll a given location or URL address for content. In the illustrated embodiment, each virtual device polls a different web page, shown at 72, 74 and 76. The user sends an instant message to a “URL” object for notification. URL availability in encoded in the URL's presence. When the URL is active, it sends an instant message notification to the user. In this way, virtual devices can be used to monitor information sources such as web sites, to detect when a predefined change has occurred. When such a change is detected, the virtual device sends an instant message to the user.

The implementation of FIG. 5 might be useful, for example, to allow a user to monitor one or more web sites for a change in pertinent information, such as a change in stock price or weather condition or breaking news event. The virtual device would detect such a change, based on the pre-programmed instructions provided to it by the user. An instant message would then be sent to the user.

In a more complex scenario, the instant message from a single virtual device may be combined with or altered based on information from other virtual devices. In this way, the user can construct new virtual devices that offer functionality not currently available. For example, the user might configure a system to monitor severe weather conditions published on a web site and concurrently, using a separate virtual device, monitor a thermometer located at the user's vacation home. The data from both virtual devices would then be combined to send an instant message to the user's cell phone when measured temperature conditions and severe weather warnings both indicate an ensuing storm. The instant message might contain both a synopsis of the weather headlines from the website together with a readout of the measured temperature at the vacation home. This is but one example. The possibilities for combining multiple virtual device information content into a new virtual device are as varied as the user's imagination. The instant messaging and presence system of the invention provides the foundation upon which such virtual creations may be built.

While the invention has been described in its presently preferred embodiments, it will be understood that the invention is capable of modification without departing from the spirit of the invention as set forth in the appended claims. Furthermore, while the invention has been described in connection with present day instant messaging technology, the principles of the invention may be readily extended to instant messaging technologies of the future, as will be appreciated by those with skill in this art.

Accordingly, the description of the invention is merely exemplary in nature and, thus, variations that do not depart from the gist of the invention are intended to be within the scope of the invention. Such variations are not to be regarded as a departure from the spirit and scope of the invention.

What is claimed is:

1. In an instant messaging system, the improvement comprising:
a virtual instant messaging system adapted to communicate instant messages between at least one first device having instant messaging capability and at least one second device or information source that does not have instant messaging capability;
the virtual instant messaging system including a semantic translation component that converts instant messages from said first device into information usable by said second device.

2. The improvement of claim 1 wherein said virtual instant messaging system further includes a physical communication handler adapted to establish physical communication with said second device.

3. The improvement of claim 1 further comprising a device synthesis component that provides capability to combine plural second devices into a new composite virtual device.

4. The improvement of claim 1 wherein said virtual instant messaging system further supports at least one presence attribute and wherein said semantic translation component translates said presence attribute into a state variable associated with said second device.

5. The improvement of claim 4 wherein said state variable provides an indication of the power source of said second device.

6. The improvement of claim 4 wherein said state variable provides an indication of the ON-OFF state of said second device.

7. The improvement of claim 4 wherein said state variable provides an indication of the memory capacity of said second device.

8. The improvement of claim 4 wherein said second device is an information source and wherein said state variable provides an indication that a change in information content of said information source has occurred.

9. The improvement of claim 1 wherein said instant messaging system polls said second device for content.

10. A method of providing instant message services, comprising:
launching a virtual instant messaging software instance, the software instance corresponding to a physical device or information source that does not inherently support instant messaging;
establishing communication with said virtual instant messaging software instance using a messaging device that supports instant messaging;
using said messaging device to interact with said physical device or information source by utilizing instant messages that are translated by said software instance into the semantics of said physical device or information source.

11. The method of claim 10 wherein said physical device is selected from the group consisting of home entertainment systems, audio/video systems, home appliances, digital cameras, video camcorders, surveillance cameras, door locks and perimeter control systems, residential gateway computer systems, GPS systems, security systems and combinations thereof.

12. The method of claim 10 wherein said information source is selected from the group consisting of internet web sites, internet ftp sites, email systems.

13. The method of claim 10 further comprising launching a second virtual instant messaging software instance corresponding to a second physical device or information source that does not inherently support instant messaging, and
using said messaging device to concurrently interact with both of said launched instant messaging software instances to thereby define a new virtual device.

14. The method of claim 10 further comprising using said virtual instant messaging software instance to poll an information source for content.

15. The method of claim 10 further comprising using said virtual instant messaging software instance to communicate state information between said physical device or information source and said messaging device using a presence attribute associated with instant messaging.

16. The method of claim 15 wherein said software instance converts the semantics of at least one physical device state variable into a presence attribute.

17. The method of claim 15 further comprising using said presence attribute to control said physical device or information source.

18. The method of claim 15 further comprising using said presence attribute to ascertain the state of said physical device or information source.

19. The method of claim 10 further comprising using a first messaging device to interact with said physical device or information source and to thereby cause said physical device or information source to interact with a second messaging device.

20. The method of claim 10 wherein said messaging device is a cellular telephone.
